(19) United States
(12) Patent Application Publication
(10) Pub. No.: US 2004/0263916 A1
(43) Pub. Date: Dec. 30, 2004

(54) Image capture apparatus with telescopic hinge

(76) Inventor: Ming-Kuan Qian, Taizhou City (CN)

Correspondence Address: SNELL & WILMER, ONE ARIZONA CENTER, 400 EAST VAN BUREN, PHOENIX, AZ, 850040001

(21) Appl. No.: 10/863,990

(22) Filed: Jun. 9, 2004

(30) Foreign Application Priority Data
Jun. 24, 2003 (TW) 92211491

(51) Int. Cl. H04N 1/04

(52) U.S. Cl. 358/474

(57) ABSTRACT

A telescopic hinge for the image capture apparatus is provided. The image capture apparatus includes a cover, a housing and a telescopic hinge. The telescopic hinge includes a sleeve set and a connection unit. The sleeve set is movably connected with housing of the image capture apparatus, and the top of the connection unit is pivotally connected to the cover of the image capture apparatus. The combination of the sleeve set and the connection unit makes the cover able to move vertically relative to the housing.

### CROSS-REFERENCE TO RELATED APPLICATIONS

This Application claims priority to Taiwan Patent Application No. 092211491 filed Jun. 24, 2003.

### FIELD OF INVENTION

The present invention provides an image capture apparatus with a telescopic hinge for use with the cover of the image capture apparatus.

### BACKGROUND OF THE INVENTION

Generally speaking, the thickness of originals to be scanned varies, so sufficient space between the cover and the housing of the image capture apparatus must be provided to accommodate originals of different thickness. Therefore, the hinge connecting the covers and the housings must have telescopic function in the axial direction for adjusting space.

Traditional scanners with charge-coupled device (CCD), for example, usually have thicker housings. So, there is enough space for hiding the hinges.

However, the trend of the scanner nowadays is decreasing the volume and weight, and the contact imaging sensor (CIS) system is introduced to decrease the thickness (inner space) of the housing. Because traditional telescopic hinges can't be drawn into the housing completely for the thinner housing nowadays, the space between the cover and the housing is limited so that the scan quality is affected.

### SUMMARY OF THE INVENTION

The present invention provides an image capture apparatus with a telescopic hinge for use with the cover of the image capture apparatus. The telescopic hinge can move in axial direction to provide space for to-be-scanned originals of different thickness.

The present invention also provides an image capture apparatus with a telescopic hinge for use with the cover of the image capture apparatus to decrease the volume of the image capture apparatus.

The telescopic hinge of the image capture apparatus of the present invention includes a sleeve set and a connection unit. The sleeve set includes at least one sleeve, and the number of sleeves depends on the user's need. The sleeve set is movably connected with the housing of the image capture apparatus. The connection unit is movably sleeved onto the sleeve set and the top of the connection unit is pivotally connected to the cover of the image capture apparatus. Owing to the combination of the sleeve set and the connection unit, the cover can move vertically relative to the housing.

### BRIEF DESCRIPTION OF THE DRAWINGS

FIG. 1 shows a schematic diagram of the image capture apparatus and the hinge of the present invention.

FIG. 2a shows a schematic diagram of the telescopic hinge of the present invention.

FIG. 2b shows a schematic diagram of the connection unit and the cover of the present invention.

FIG. 3 shows a profile of the telescopic hinge of the present invention.

FIG. 4 shows a profile of the sleeve set of an embodiment of the present invention.

FIG. 5 shows a perspective view of the telescopic hinge of the embodiment of the present invention.

FIG. 6 shows a profile of the embodiment of the convex portion of the present invention.

### DETAILED DESCRIPTION OF THE INVENTION

The present invention provides an image capture apparatus with a telescopic hinge for use with the cover of the image capture apparatus. The preferred embodiment of the image capture apparatus is a scanner. Other embodiments can be a copier or other devices having similar functions.

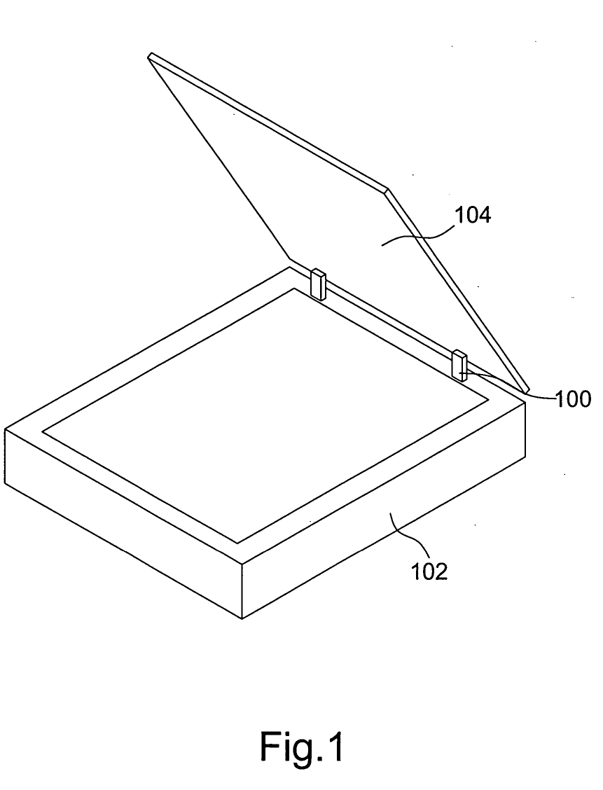

FIG. 1 shows a schematic diagram of the image capture apparatus and the hinge of the present invention. The image capture apparatus includes a housing 102 and a cover 104, and the telescopic hinge 100 connects the housing 102 and the cover 104. The housing 102 contains the light-sensitive element and other components. The cover 104 obstructs the outer light source and provides a background for the to-be-scanned original during image capture procedure.

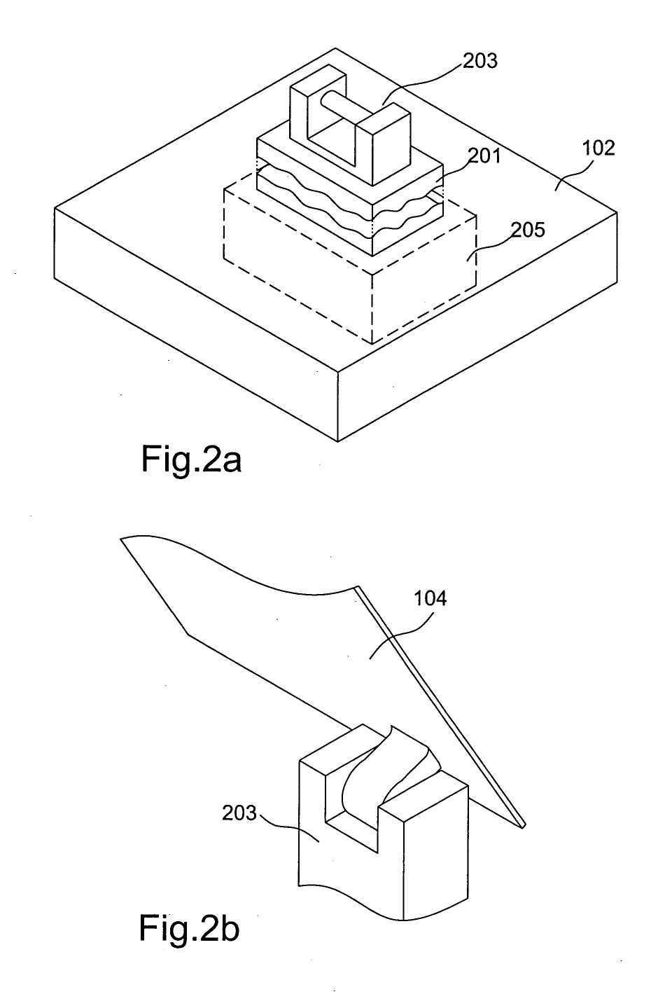

FIG. 2a shows a schematic diagram of the telescopic hinge of the present invention. The telescopic hinge 100 includes a sleeve set 201 and a connection unit 203. The bottom sleeve of the sleeve set 201 is movably connected to the housing 102, and the sleeve set 201 can selectively recoil into the housing 102. The sleeve set 201 includes at least one sleeve, and the number of sleeves depends on the user's need. The sleeve set 201 can move relative to the housing 102 in axial direction to provide space for scanning originals of different thickness. The connection unit 203 is movably sleeved onto the top sleeve of the sleeve set 201. FIG. 2b shows a schematic diagram of the connection unit and the cover of the present invention. As shown in FIG. 2b, the top of the connection unit 203 is pivotally connected to the cover 104, making the cover 104 able to move vertically relative to the housing 102.

As shown in FIG. 2a, the part of the housing 102 connected to the telescopic hinge 100 further includes a duct structure 205, and the bottom sleeve of the sleeve set 201 is sleeved onto the duct structure 205. The guidance function of the duct structure 205 makes the sleeve set 201 able to move relative to the housing 102 in the axial direction. In the embodiment illustrated in FIG. 2a, the duct structure 205 and the housing 102 are formed as integrity; however, the duct structure 205 can be connected to the housing 102 as an external part in other embodiments.

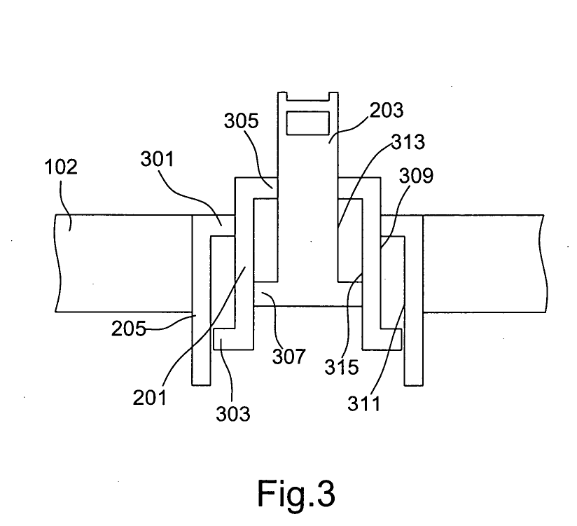

FIG. 3 shows a profile of the telescopic hinge of the present invention. An inner sidewall 311 of the duct structure 205 includes a first convex portion 301 protruding inward, and an outer sidewall 309 of the sleeve set 201 includes a second convex portion 303 protruding outward. When the sleeve set 201 stretches out from the housing 102, the first convex portion 301 engages with the second convex portion 303 to prevent detachment of the sleeve set 201 from the duct structure 205. An inner sidewall 315 of the sleeve set 201 includes a third convex portion 305 protruding inward, and an outer sidewall 313 of the connection unit 203 includes a fourth convex portion 307 protruding outward. When the connection unit 203 stretches out from the sleeve set 201, the third convex portion 305 engages with the fourth convex portion 307 to prevent detachment of the connection unit 203 from the sleeve set 201.

As shown in FIG. 3, the first convex portion 301 is at the top of the inner sidewall 311 of the duct structure 205. However, the first convex portion 301 can be disposed in different positions of the inner sidewall 311 of the duct structure 205 according to the user's need.

As shown in FIG. 3, the second convex portion 303 is at the bottom of the outer sidewall 309 of the sleeve set 201, and the third convex portion 305 is at the top of the inner sidewall 315 of the sleeve set 201. However, the second convex portion 303 and the third convex portion 305 can be respectively disposed in different positions of the outer sidewall 309 and the inner sidewall 315 of the sleeve set 201 according to the user's need.

As shown in FIG. 3, the fourth convex portion 307 is connected to the bottom of the outer sidewall 313 of the connection unit 203. In other embodiments, the fourth convex portion 307 can be disposed in different positions of the connection unit 203 according to the user's need.

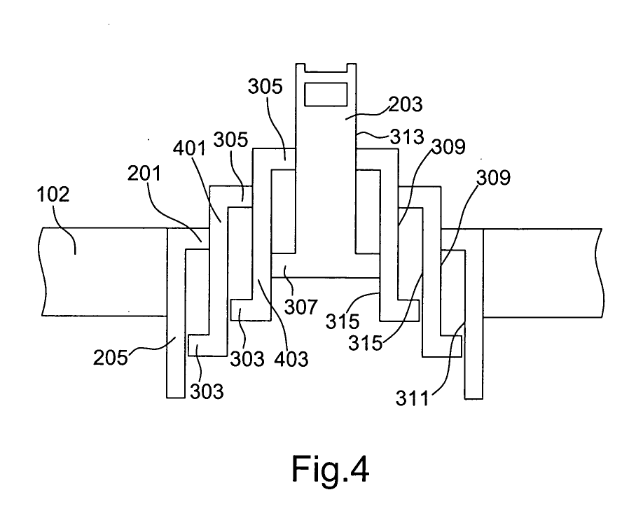

FIG. 4 shows a profile of an embodiment of the sleeve set of the present invention. In this embodiment, the sleeve set 201 includes an inner sleeve 403 and an outer sleeve 401. The inner sleeve 403 is movably sleeved onto in the outer sleeve 401. The outer sidewall 309 of the inner sleeve 403 includes a second convex portion 303 protruding outward. The inner sidewall 315 of the outer sleeve 401 includes a third convex portion 305 protruding inward. When the inner sleeve 403 stretches out from the outer sleeve 401, the second convex portion 303 engages with the third convex portion 305 to prevent detachment of the inner sleeve 403 from the outer sleeve 401.

As shown in FIG. 4, the second convex portion 303 is disposed near the bottom of the outer sidewall 309 of the inner sleeve 403. The third convex portion 305 is disposed near the top of the inner sidewall 315 of the outer sleeve 401. However, in other embodiments, the positions of the second convex portion 303 and the third convex portion 305 are adjustable to fit the user's need.

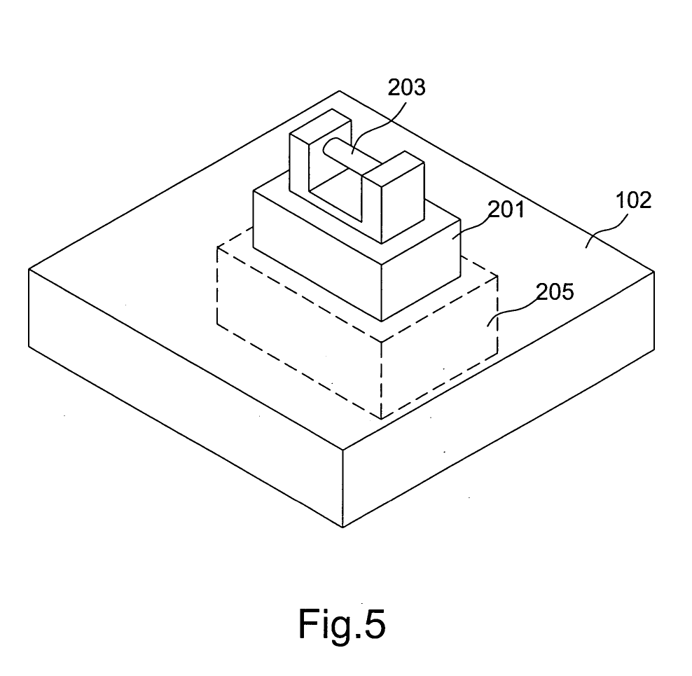

FIG. 5 shows a perspective view of the telescopic hinge of the embodiment of the present invention. As shown in FIG. 5, the duct structure 205, the sleeve set 201 and the connection unit 203 are in the form of cuboids. In other embodiments, the duct structure 205, the sleeve set 201 and the connection unit 203 can be in the form of cylinders, triangular prisms or other specific shapes to fit the user's need.

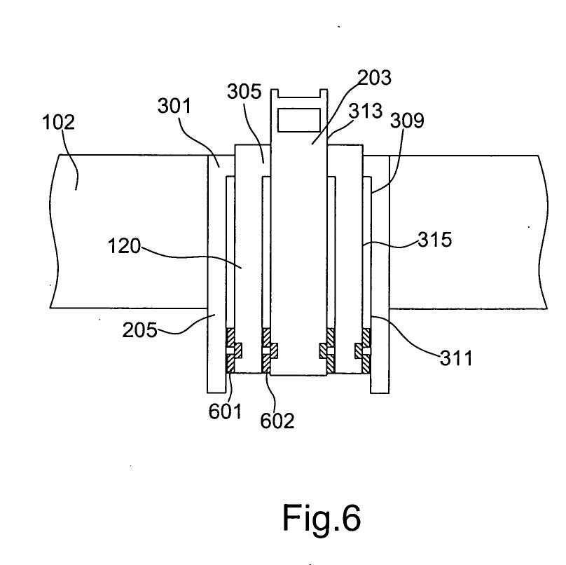

As shown in FIG. 3, the first convex portion 301, the second convex portion 303, the third convex portion 305 and the fourth convex portion 305 are flanges protruding from the ends of the duct structure 205, the sleeve set 201 and the connection unit 203 respectively. However, in the embodiment illustrated in FIG. 6, a first bushing 601 is sleeved onto the outer bottom of the sleeve set 201 to provide the same function that the second convex portion 303 provides. A second bushing 602 is sleeved onto the outer bottom of the connection unit 203 to provide the same function that the fourth convex portion 307 provides. The second convex portion 303 and the fourth convex portion 307 formed by the first bushing 601 and the second bushing 602 also provide functions of increasing friction and reducing vibration. It should be noticed here that a similar bushing can be employed to provide the function of the third convex portion 305.

While the invention has been described in connection with what is presently considered to be the most practical and preferred embodiments, it is to be understood that the invention is not to be limited to the embodiments set forth herein. The invention is intended to cover various modifications and equivalent arrangement included within the spirit and scope of the appended claims.

I claim:

1. An image capture apparatus including a telescopic hinge, a housing and a cover, the telescopic hinge comprising:
a sleeve set including at least a sleeve, the sleeve set defining an axial direction and movably connecting with the housing in the axial direction to slide into the housing selectively; and
a connection unit having a top pivotally connects to the cover, the connection unit movably and sleevably connecting to the sleeve allowing the cover move vertically relative to the housing.

2. The image capture apparatus of claim 1, wherein the housing includes a duct structure, and the sleeve set is sleevably connected with the duct structure.

3. The image capture apparatus of claim 2, wherein an inner sidewall of the duct structure includes a first convex portion, and an outer sidewall of the sleeve set includes a second convex portion, and as the sleeve set stretches out of the housing, the first convex portion contacts against the second convex portion to prevent detachment of the sleeve set from the duct structure.

4. The image capture apparatus of claim 3, wherein the first convex portion is on the inner sidewall of the duct structure and near a top of the duct structure.

5. The image capture apparatus of claim 3, wherein the second convex portion is on the outer sidewall of the sleeve set and near a bottom of the sleeve set.

6. The image capture apparatus of claim 3, wherein the first convex portion is a flange.

7. The image capture apparatus of claim 2, wherein an inner sidewall of the duct structure includes a first convex portion, and an outer sidewall of the sleeve set sleevably connects with a first bushing, and as the sleeve set stretches out of the housing, the first convex portion contacts against the first bushing to prevent detachment of the sleeve set from the duct structure.

8. The image capture apparatus of claim 7, wherein the first convex portion is on the inner sidewall of the duct structure and near a top of the duct structure.

9. The image capture apparatus of claim 7, wherein the first bushing is on the outer sidewall of the sleeve set and near a bottom of the sleeve set.

10. The image capture apparatus of claim 1, wherein an inner sidewall of the sleeve includes a third convex portion, and an outer sidewall of the connection unit includes a fourth convex portion, and as the connection unit stretches out of the duct structure, the third convex portion contacts against the fourth convex portion to prevent detachment of the connection unit from the duct structure.

11. The image capture apparatus of claim 10, wherein the third convex portion is on the inner sidewall of the duct structure and near a top of the duct structure.

12. The image capture apparatus of claim 10, wherein the fourth convex portion is on the outer sidewall of the connection unit and near a bottom of the connection unit.

13. The image capture apparatus of claim 10, wherein the third convex portion is a flange.

14. The image capture apparatus of claim 1, wherein an inner sidewall of the sleeve includes a third convex portion, and an outer sidewall of the connection unit sleevably connects with a second bushing, and as the connection unit stretches out of the duct structure, the third convex portion contacts against the second bushing to prevent detachment of the connection unit from the duct structure.

15. The image capture apparatus hinge of claim 14, wherein the third convex portion is on the inner sidewall of the duct structure and near a top of the duct structure.

16. The image capture apparatus of claim 14, wherein the second bushing is on the outer sidewall of the connection unit and near a bottom of the connection unit.

17. The image capture apparatus of claim 1, wherein the sleeve set includes:
an outer sleeve including an inner sidewall, the inner sidewall including a third convex portion; and
an inner sleeve including an outer sidewall, the outer sidewall including a second convex portion, the inner sleeve movably sleevably connecting to the outer sleeve;
wherein as the inner sleeve stretches out of the outer sleeve, the second convex portion contacts against the third convex portion to prevent detachment of the inner sleeve from the outer sleeve.

18. The image capture apparatus of claim 17, wherein the third convex portion is on the inner sidewall of the outer sleeve and near a top of the outer sleeve.

19. The image capture apparatus of claim 17, wherein the second convex portion is on the outer sidewall of the inner sleeve and near a bottom of the inner sleeve.

20. image capture apparatus of claim 1, wherein the sleeve set includes:
an outer sleeve including an inner sidewall, the inner sidewall including a third convex portion; and
an inner sleeve including an outer sidewall, the outer sidewall including a first bushing, the inner sleeve movably sleevably connecting to the outer sleeve;
wherein as the inner sleeve stretches out of the outer sleeve, the first bushing contacts against the third convex portion to prevent detachment of the inner sleeve from the outer sleeve.
